(19) United States
(12) Patent Application Publication
(10) Pub. No.: US 2003/0197333 A1
(43) Pub. Date: Oct. 23, 2003

(54) Air preheater sector plate bypass seal

(75) Inventors: Michael Zakel, Wellsville, NY (US); Kevin J. O'Boyle, Alma, NY (US)

Correspondence Address: Alix, Yale & Ristas, LLP, 750 Main Street, Hartford, CT, 06103-2721, US

(73) Assignee: ALSTOM (Switzerland) Ltd

(21) Appl. No.: 10/125,252

(22) Filed: Apr. 18, 2002

(51) Int. Cl. F16J 15/32

(52) U.S. Cl. 277/551

(57) ABSTRACT

A sector plate bypass seal includes a seal bar which engages the outboard end portion of the hot end sector plate and the portion of the housing proximate to the sector plate to close the gap therebetween. At least one bar clip has an upper segment mounted to the hot end center section and a lower segment mounted to the seal bar to hold the seal bar in axial position. At least one seal clamp is mounted to the outboard end portion of the sector plate and slidingly engages the seal bar to hold the seal bar in close engagement with the sector plate and housing portion while allowing vertical relative movement between the seal bar and the sector plate.

### BACKGROUND OF THE INVENTION

The present invention relates to the apparatus of a rotary regenerative air preheater. More particularly, the invention relates to the sector plate bypass seals of an air preheaters.

A rotary regenerative air preheater transfers sensible heat from the flue gas leaving a boiler to the entering combustion air through regenerative heat transfer surface in a rotor which turns continuously through the gas and air streams. The rotor, which is packed with the heat transfer surface, is divided into compartments by a number of radially extending plates referred to as diaphragms. These compartments are adapted to hold modular baskets in which the heat transfer surface is contained.

The air preheater is divided into a flue gas side or sector and one or more combustion air sides or sectors by sector plates. Flexible radial seals on the rotor, usually mounted on the top and bottom edges of the diaphragms, are in close proximity to these sector plates and minimize leakage of gas and air between sectors. In a typical rotary regenerative heat exchanger, an axial temperature gradient exists from the hot end of the rotor to the cold end of the rotor which distorts the rotor (commonly referred to as rotor turndown). As a result, the radial seals mounted on the top edges of the diaphragms are pulled away from the sector plates with the greater separation occurring at the outer radius of the rotor. This opens a gap permitting the undesired intermingling of the gas and the air.

Various schemes have been developed to maintain the seal between the radial seals mounted on the diaphragms and the sector plates during this temperature change. In one such scheme, a sector plate drive moves the outer end portions of the sector plates as the temperature increases so as to maintain the sector plates engaged with or in close proximity to the radial seals. Since the outer ends of the sector plates must be free to move, a bypass leakage path is created around the ends of the sector plates. Such bypass leakage paths are also present in air preheaters having sector plates which require adjustment over the lifetime of the air preheater. Conventional seals for preventing such bypass flow are multi-part assemblies which must be assembled at least in part and installed in the field. Further, access doors in the housing must be provided to allow adjustment of components of such seals during installation.

### SUMMARY OF THE INVENTION

Briefly stated, the invention in a preferred form is a sector plate bypass seal which includes a seal bar which engages the outboard end portion of the hot end sector plate and the portion of the housing proximate to the sector plate to close the gap therebetween. At least one bar clip has an upper segment mounted to the hot end center section and a lower segment mounted to the seal bar to hold the seal bar in axial position. At least one seal clamp is mounted to the outboard end portion of the sector plate and slidingly engages the seal bar to hold the seal bar in close engagement with the sector plate and housing portion while allowing vertical relative movement between the seal bar and the sector plate.

The seal bar has a curved-shape which is complimentary to the curved shape of the outboard end portion of the sector plate, with the concave radially-inboard face of the seal bar engaging the outboard end portion of the sector plate. An axially-inner end of the seal bar slidingly engages the housing portion. The outboard end portion of the sector plate, the seal bar, the outboard end plate and the housing portion are each composed of substantially the same material.

The seal bar has first and second end portions and a mid portion separated from the first and second end portions by first and second intermediate portions, respectively. The first and second end portions and mid portion have an axial height which is greater than that of the intermediate portions, such that a circumferentially extending notch is formed between the mid portion and each end portion. At least one of the seal clamps is positioned within each notch of the seal bar.

Each seal clamp includes a plate having radially inner and outer faces and a block member having a radially inner end mounted to the outboard end portion of the hot end sector plate and a radially outer end mounted to a corner segment of the radially inner face of the plate. A portion of the plate extending circumferentially and axially over a portion of the seal bar. radial thickness of the block member being is equal to, or slightly greater than, the radial thickness of the seal bar.

### BRIEF DESCRIPTION OF THE DRAWINGS

The present invention may be better understood and its numerous objects and advantages will become apparent to those skilled in the art by reference to the accompanying drawings in which:

FIG. 1 is a general perspective view of a conventional rotary regenerative air preheater.

FIG. 2 is a partial isometric view of a sector plate bypass seal in accordance with the invention installed between the sector plate and the center section of an air preheater.

FIG. 3 is an enlarged cross section view taken along line 3-3 of FIG. 2.

FIG. 4 is an enlarged view of area IV of FIG. 3.

FIG. 5 is an enlarged partial horizontal cross section view of the sector plate bypass seal of FIG. 2.

FIG. 6 is an enlarged top view of the bypass bar of FIG. 2.

FIG. 7 is a front view of the bypass bar of FIG. 6.

FIG. 8 is an enlarged side view of the bar clip of FIG. 2.

FIG. 9 is an enlarged side view of the seal clamp of FIG. 2.

FIG. 10 is a front view of the seal clamp of FIG. 9.

### DETAILED DESCRIPTION OF THE PREFERRED EMBODIMENT

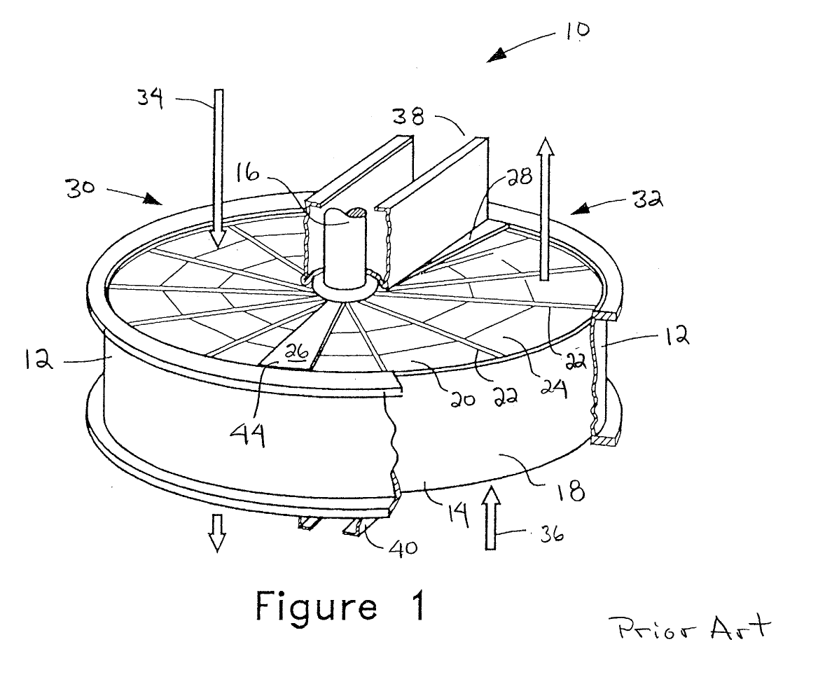

FIG. 1 of the drawings is a partially cut-away perspective view of a typical bi-sector air preheater 10 showing a housing 12 in which the rotor 14 is mounted on a drive shaft or post 16. The rotor has a shell 18 and is divided into a plurality of pie-shaped compartments 20 by the diaphragm plates 22 with each compartment containing a plurality of heat exchange basket modules 24. The housing 12 is divided by means of the flow impervious sector plates 26 and 28 into a flue gas sector 30 and an air sector 32. Corresponding sector plates are also located on the bottom of the unit. The hot flue gases enter the air preheater 10 as indicated by the arrow 34 flow through the flue gas sector 30 where heat is transferred to the heat transfer surface in the rotor 14. As this hot heat transfer surface then rotates through the air sector 32, the heat is transferred to the air flowing through the rotor from the bottom as indicated by the arrow 36. Consequently, the cold air inlet and the cooled gas outlet define a cold bottom end and the hot gas inlet and the heated air outlet define a hot top end. Located on the top end of the housing 12 is the hot end center section 38 with a corresponding cold end center section 40 on the bottom end. The hot end center section 38 is supported from the cold end center section 40 by pedestals 42 on each end of the center sections 38, 40.

In certain air preheaters, the radially outboard end portions 44 of the hot end sector plates 26, 28 are axially moveable such that the end portions 44 may be driven toward the cold end to maintain the seal between radial seals (not shown) mounted on the diaphragm plates 22 and the sector plates 26, 28 during operation of the air preheater 10. Consequently, a seam weld may not be used to close the gap 46 between the outboard ends 48 of the sector plates 26, 28 and the housing portion 50 proximate to the sector plate, such as the main pedestals 42, providing a bypass leakage path therebetween. In other air preheaters, the position of the hot end and/or the cold end sector plates 26, 28 must be adjusted one or more times over the lifetime of the air preheater. If a seam weld is used to fill the sector plate-housing gap 46 in such an air preheater, the weld will have to be ground-out before each such adjustment and a new seam will have to be welded in place at the completion of the adjustment. Bypass leakage seals that have been used heretofore have been multi-part assemblies which included expensive, high temperature springs to close the sealing gap 46. The springs were subject to failure, thereby requiring replacement. The seal assemblies required at least some assembly in the field and various components of the assembly required adjustment during installation. To provide for replacement of the springs/seals and adjustment of seal components, access doors in the housing were required.

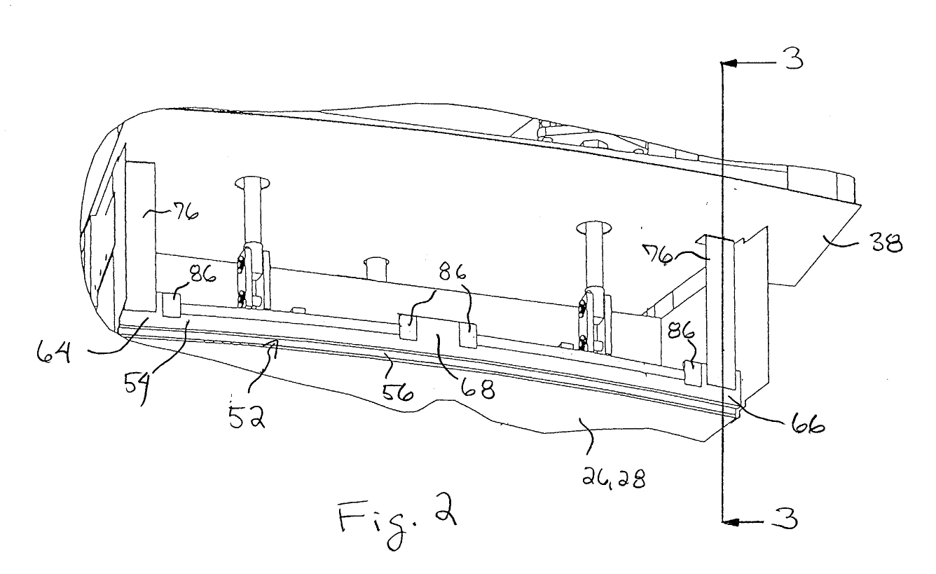

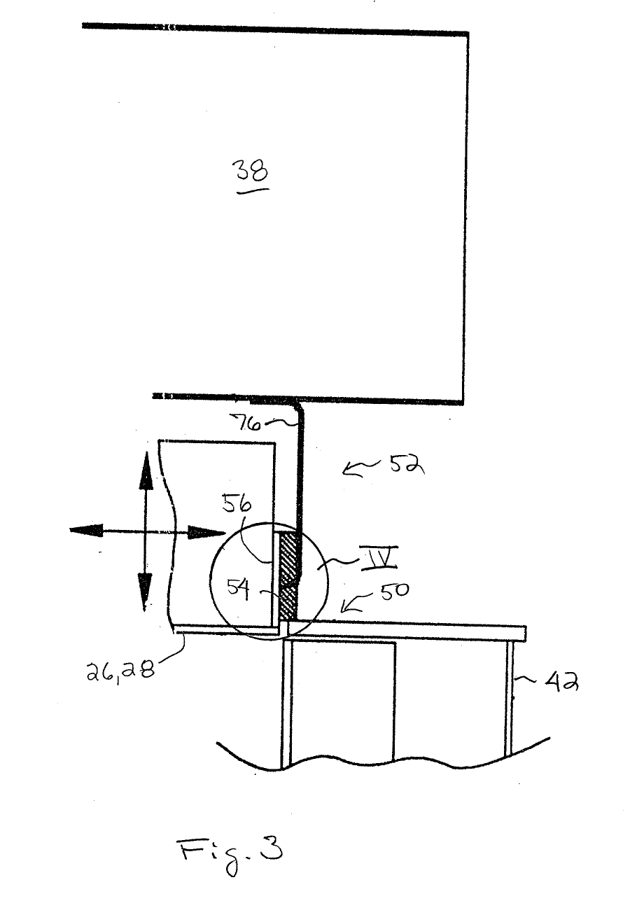

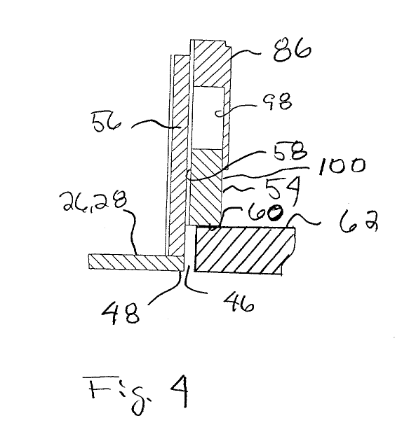

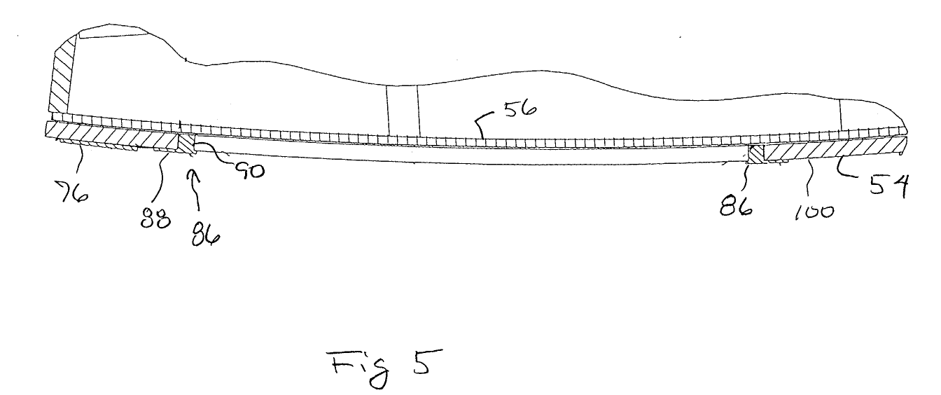

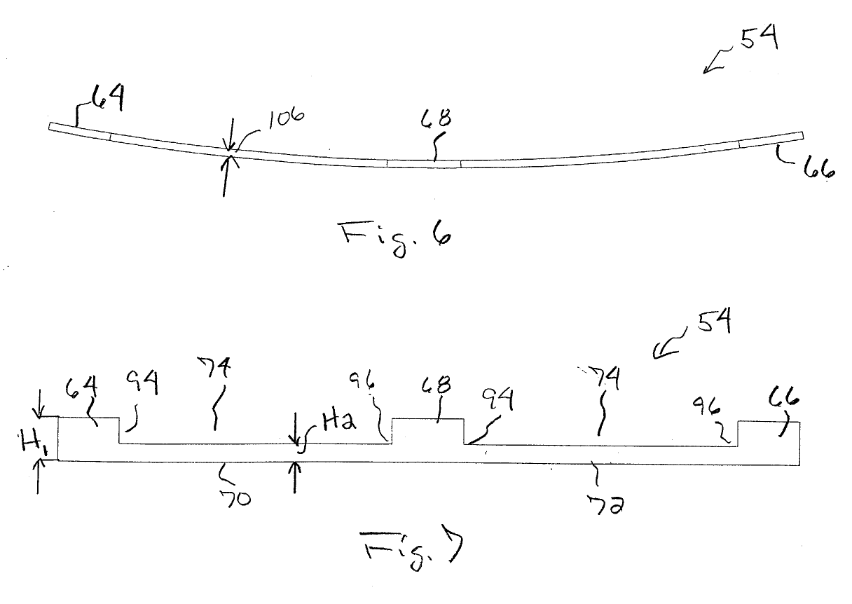

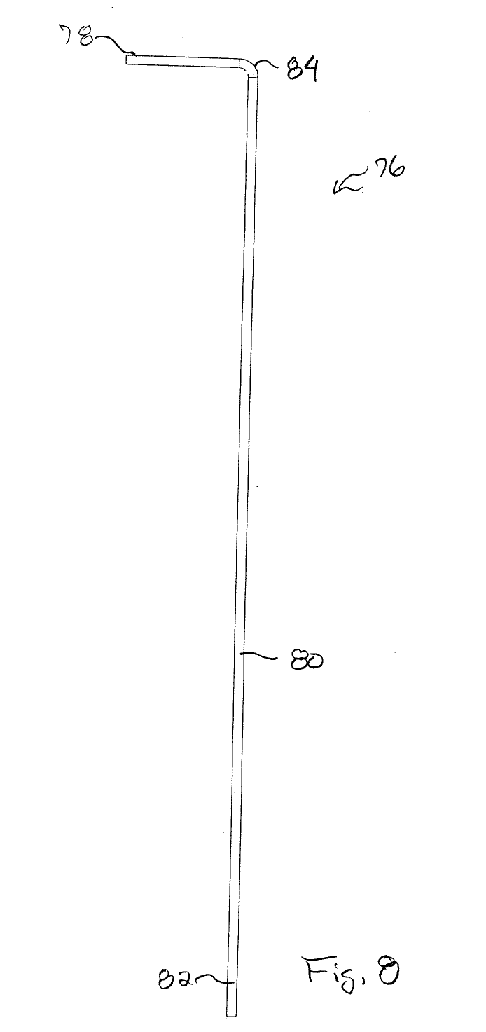

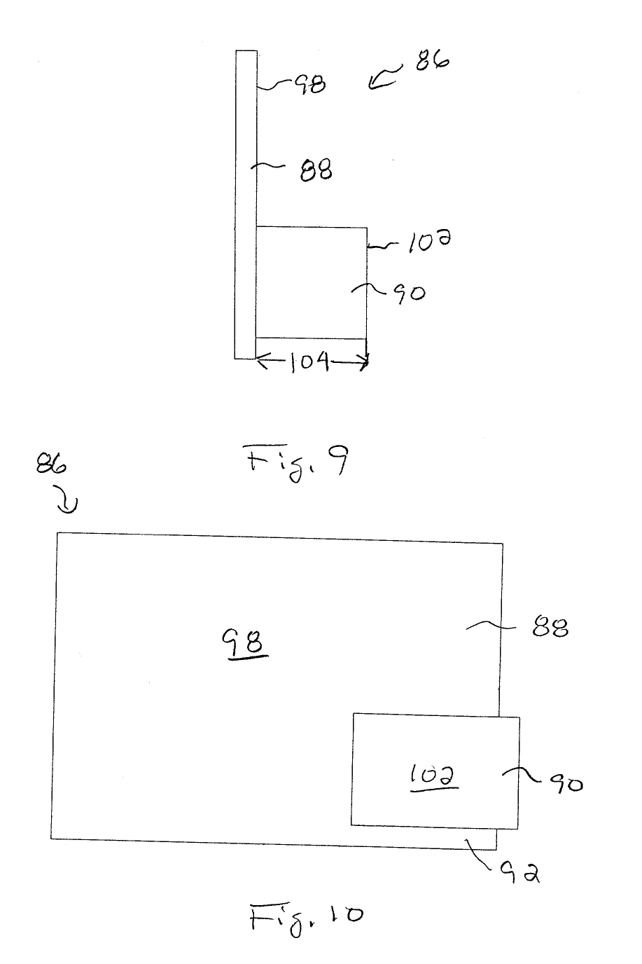

With reference to FIGS. 2-4, a sector plate bypass seal 52 in accordance with the invention includes a seal bar 54 which fills the gap 46 between a sector plate 26, 28 and an associated housing portion 50, such as the main pedestal 42. The seal bar 54 has a curved shape, when viewed from the axial direction (FIG. 6), which is complimentary to curved shape of the rotor outboard end plate 56 and the housing inner surface such that the inboard face 58 of the seal bar 54 engages the outboard end plate 56 of the sector plate 26, 28 and the axially-inner end 60 of the seal bar 54 engages an axially-outer end surface 62 of the housing portion 50 to close the gap 46. Such engagement provides for sliding contact between inboard face 58 and outboard end plate 56 and between inner end 60 and outer end surface 62 to allow for differential thermal expansion between the sector plate 28, 26 and the hot end center section 38 and housing 12.

The seal bar 54 extends circumferentially from a first end portion 64 to a second end portion 66. A mid portion 68 is centered between the two end portions 64, 66 and is separated from the first and second end portions 64, 66 by first and second intermediate portions 70, 72, respectively. The end portions 64, 66 and mid portion 68 have substantially the same axial height H₁ and the intermediate portions 70, 72 have substantially the same axial height H₂, with H₁>H₂, such that a notch 74 is formed between the mid portion 68 and each end portion 64, 66. Preferably, the seal bar 54 is composed of the same material as the outboard end plate 56 and housing portion 50 such that any wear due to differential expansion will borne equally by all three components. Since the seal bar 54 does not wear at a faster rate than the sector plate 26, 28 or the housing 12, it is estimated that the seal bar 54 will not have to be replaced during the expected lifetime of the air preheater 10.

Two bar clips 76, one mounted to each end portion 64, 66 of the seal bar 54, hold the seal bar 54 vertically in position and in engagement with housing portion 50. Each L-shaped bar clip 76 has a horizontally extending upper segment 78 mounted to center section 38. A lower segment 80 extends vertically downward from the upper segment 78 to a lower end 82 which mounted to an end portion 64, 66 of the seal bar 54. The upper and lower segments 78, 80 are each preferably mounted to center section 38 and seal bar 54, respectively, by a weld. The upper segment 78 is connected to the lower segment 80 by a large radius bend 84, preferably a ¼ inch radius, or larger, to allow the bar clip 76 to flex with thermally induced relative movement between the sector plate 26, 28 and center section 38.

Four seal clamps 86 hold the seal bar 54 in close engagement with the sector plate 26, 28 and housing portion 50 while allowing vertical relative movement between the seal bar 54 and the sector plate 26, 28. Each seal clamp 86 includes a plate 88 and a block member 90 mounted to a corner segment 92 of the plate 88. A seal clamp 86 is positioned at each end 94, 96 of each notch 74, with the radially inner face 98 of the plate 88 positioned adjacent the radially outer face 100 of the seal bar 54. Each plate 88 extends circumferentially and axially over a portion of the seal bar 54 to facilitate engagement therebetween. The block member 90 extends from the radially inner face 98 of the plate 88 to a radially inner end 102 which is mounted to the outboard end plate 56 of the sector plate 26, 28, preferably by a weld. The radial thickness 104 of the block member 90 is substantially equal to, or slightly greater than, the radial thickness 106 of the seal bar 54, both preferably being equal to one inch.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A sector plate bypass seal for a rotary regenerative air preheater having a housing, a rotor disposed within the housing and rotating around a vertical axis, a heated air outlet and a flue gas inlet defining an upper hot end, an air inlet and a flue gas outlet defining a lower cold end, and hot end and cold end sector plates dividing the air preheater into a flue gas sector and at least one air sector, the housing including a hot end center section supported on a cold end center section, each hot end sector plate having a curved outboard end portion defining a gap with an associated housing portion, the sector plate bypass seal comprising:
a seal bar engaging the outboard end portion of the hot end sector plate and the associated housing portion to close the gap;
at least one bar clip having an upper segment mounted to the hot end center section and a lower segment mounted to the seal bar; and
at least one seal clamp mounted to the outboard end portion of the sector plate and slidingly engaged with the seal bar;
whereby the bar clip holds the seal bar in axial position and the seal clamp holds the seal bar in close engagement with the sector plate and housing portion while allowing vertical relative movement between the seal bar and the sector plate.

2. The sector plate bypass seal of claim 1 wherein the seal bar has a curved-shape which is complimentary to the curved shape of the outboard end portion of the sector plate.

3. The sector plate bypass seal of claim 2 wherein the seal bar has a concave radially-inboard face and an axially-inner end slidingly engaging the outboard end portion of the sector plate and the associated housing portion, respectively.

4. The sector plate bypass seal of claim 1 wherein the sector plate includes an outboard end plate defining the outboard end portion of the sector plate, the seal bar, the outboard end plate and the housing portion each being composed of substantially the same material.

5. The sector plate bypass seal of claim 1 wherein the seal bar has first and second end portions and a mid portion separated from the first and second end portions by first and second intermediate portions, respectively.

6. The sector plate bypass seal of claim 5 wherein the first and second end portions and mid portion have substantially the same axial height H₁ and the intermediate portions have substantially the same axial height H₂, H₁ being greater than H₂, whereby a circumferentially extending notch is formed between the mid portion and each end portion.

7. The sector plate bypass seal of claim 6 wherein at least one of the seal clamps is positioned within each notch of the seal bar.

8. The sector plate bypass seal of claim 7 wherein each seal clamp includes a plate having radially inner and outer faces and a block member having a radially inner end mounted to the outboard end portion of the hot end sector plate and a radially outer end mounted to a corner segment of the radially inner face of the plate, a portion of the plate extending circumferentially and axially over a portion of the seal bar.

9. The sector plate bypass seal of claim 8 wherein the seal bar and the block member each have a radial thickness, the radial thickness of the block member being substantially equal to the radial thickness of the seal bar.

10. The sector plate bypass seal of claim 1 wherein the seal bar has first and second end portions and a one of the bar clips is mounted to each end portion of the seal bar.

11. The sector plate bypass seal of claim 10 wherein the upper segment of each bar clip extends horizontally from the lower segment, the upper segment being connected to the lower segment by a bend having a radius of at least ¼ inch.

12. A sector plate bypass seal for a rotary regenerative air preheater having a housing, a rotor disposed within the housing and rotating around a vertical axis, a heated air outlet and a flue gas inlet defining an upper hot end, an air inlet and a flue gas outlet defining a lower cold end, and hot end and cold end sector plates dividing the air preheater into a flue gas sector and at least one air sector, the housing including a hot end center section supported on a cold end center section, each hot end sector plate having a curved outboard end portion defining a gap with an associated housing portion, the sector plate bypass seal comprising:
a seal bar having a curved-shape which is complimentary to the curved shape of the outboard end portion of the sector plate, first and second end portions, a radially-inboard face engaging the outboard end portion of the hot end sector plate and an axially-inner end slidingly engaging the associated housing portion to close the gap;
a plurality of bar clips, each of the bar clips having an upper segment mounted to the hot end center section, a lower segment of at least one bar clip being mounted to each end portion of the seal bar; and
a plurality of seal clamps, each seal clamp including a plate and a block member having a radially inner end mounted to the outboard end portion of the hot end sector plate and a radially outer end mounted to the plate, a portion of the plate extending circumferentially and axially over a portion of the seal bar.
